(19) United States
(12) Patent Application Publication
(10) Pub. No.: US 2005/0107163 A1
(43) Pub. Date: May 19, 2005

(54) Methods and apparatus for providing an electronic operational event trail for a gaming apparatus

(76) Inventors: Binh T. Nguyen, Reno, NV (US); Greg Parrott, Reno, NV (US); Craig A. Paulsen, Reno, NV (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/712,550

(22) Filed: Nov. 13, 2003

(51) Int. Cl. A63F 13/00

(52) U.S. Cl. 463/42; 463/25; 463/29

(57) ABSTRACT

A gaming apparatus may comprise a display unit, a value input device, a single-write data storage device, and a controller operatively coupled to the display unit, the value input device and the data storage device. The controller may comprise a processor and a memory, and may be programmed to cause said display unit to generate a game display relating to one of the following games: poker, blackjack, slots, keno or bingo, to communicate data representing operational events on said gaming apparatus to said single-write data storage device, to determine a value payout associated with an outcome of a game, and to issue a ticket voucher comprising at least a portion of said operational event data and said value payout.

### BACKGROUND

This patent is directed to a gaming apparatus, which could be either an individual gaming unit or a gaming system having a plurality of gaming units, each gaming unit being able to write operational event data to a single-write data storage device.

Conventional gaming units have temporarily stored operational event data in a memory on a first in, first out (FIFO) basis. The memory had a limited storage capability and only stored operational event data for only a few of the most recent games. Generally, only certain types of operational event data was stored. When new data was written to the memory, old data was pushed out. If the operational event data was not retrieved for more permanent storage, the data was lost.

Government regulations required some types of operational event data, such as data printed on a cash-redeemable ticket voucher, to be stored for auditing. The data had to remain unaltered and reliable. When a ticket voucher was printed, conventional gaming units have printed the data on a roll of 2-ply paper locked within the housing of the gaming unit. The paper was used up quickly and had to be replaced often (e.g., every few days). A single conventional gaming unit could generate over a hundred used paper rolls per year. The rolls were stored for future auditing and data mining, which could take years. Auditing and data mining often proved to be difficult if specific information was sought among several thousands paper rolls. The paper was also bulky, costly, labor intensive and subject to the effects of the storage environment.

Conventional gaming systems have transmitted operational event data from multiple gaming units to a central data repository for archiving. Using a single central repository often tended to slow data transfers because all data was flowing to a single point. If the central repository failed or was destroyed, all the operational event data could be lost and new data could also be lost because only the gaming unit memory was limited. Other conventional gaming systems use a plurality of data repositories, each of which store only a particular type of operational event data. If a data repository for a particular type of operational event data failed or was destroyed, operational event data of that type could be lost, and any additional operational event data of that type could not be permanently stored.

### SUMMARY OF THE INVENTION

In one aspect, the invention is directed to a gaming system that may include a server computer, a network computer operatively coupled to the server computer and a plurality of gaming apparatuses operatively coupled to the network computer. The network computer may include a single-write data storage device and an operational event controller operatively coupled to the single-write data storage device. The operational event controller may include a processor and a memory operatively coupled to the processor. The operational event controller may be programmed to retrieve operational event data, to permanently store the operational event data on the data storage device, and to communicate the operational event data to the server computer upon a request from the server computer for the operational event data.

Each gaming apparatus may include a display unit, a ticket printer capable of generating ticket vouchers, a value input device, and a controller operatively coupled to the display unit, the ticket printer and the value input device. The controller may include a processor and a memory operatively coupled to the processor. The controller may be programmed to cause the display unit to generate a game display relating to a game, to determine a value payout associated with an outcome of the game, to communicate the operational event data to the operational event controller, and to cause the ticket printer to issue a ticket voucher comprising at least a portion of the operational event data. The operational event data may comprise accounting data, cashless data, security data, player tracking data or maintenance data.

In another aspect, the invention is directed to a gaming apparatus that may include a display unit, a value input device, a single-write data storage device, and a controller operatively coupled to the display unit, the value input device and the data storage device. The controller may include a processor and a memory operatively coupled to the processor. The controller may be programmed to cause the display unit to generate a game display relating to one of the following games: poker, blackjack, slots, keno or bingo. The controller may also be programmed to communicate data representing operational events on the gaming apparatus to the single-write data storage device, to determine a value payout associated with an outcome of the game, and to issue a ticket voucher comprising at least a portion of the operational event data and the value payout.

In yet another aspect, the invention is directed to a memory having a computer program stored therein. The computer program may be capable of being used in connection with a gaming apparatus. The memory may include a memory portion physically configured in accordance with computer program instructions that would cause the gaming apparatus to cause a game display representing one of the following games to be generated: poker, blackjack, slots, keno or bingo, a memory portion physically configured in accordance with computer program instructions that would cause the gaming apparatus to communicate data representing operational events on the gaming apparatus to a single-write data storage device, the operational event data comprising one or more of the following data types: accounting data, cashless data, security data, player tracking data and maintenance data, a memory portion physically configured in accordance with computer program instructions that would cause the gaming apparatus to determine a value payout associated with an outcome of the one game, and a memory portion physically configured in accordance with computer program instructions that would cause the gaming apparatus to issue a ticket voucher comprising at least a portion of the operational event data and the value payout.

Additional aspects of the invention are defined by the claims of this patent.

### BRIEF DESCRIPTION OF THE DRAWINGS

FIG. 1 is a block diagram of an embodiment of a gaming system in accordance with the invention;

FIG. 2 is a perspective view of an embodiment of one of the gaming units shown schematically in FIG. 1;

FIG. 2A illustrates an embodiment of a control panel for a gaming unit;

FIG. 3 is a block diagram of the electronic components of the gaming unit of FIG. 2;

FIG. 3A is a block diagram of an operational event recorder shown schematically in FIG. 3;

FIG. 4 is a flowchart of an embodiment of a main routine that may be performed during operation of one or more of the gaming units;

FIG. 5 is a flowchart of an alternative embodiment of a main routine that may be performed during operation of one or more of the gaming units;

FIG. 6 is an illustration of an embodiment of a visual display that may be displayed during performance of the video poker routine of FIG. 8;

FIG. 7 is an illustration of an embodiment of a visual display that may be displayed during performance of the video blackjack routine of FIG. 9;

FIG. 8 is a flowchart of an embodiment of a video poker routine that may be performed by one or more of the gaming units;

FIG. 9 is a flowchart of an embodiment of a video blackjack routine that may be performed by one or more of the gaming units;

FIG. 10 is an illustration of an -embodiment of a visual display that may be displayed during performance of the slots routine of FIG. 12;

FIG. 11 is an illustration of an embodiment of a visual display that may be displayed during performance of the video keno routine of FIG. 13;

FIG. 12 is a flowchart of an embodiment of a slots routine that may be performed by one or more of the gaming units;

FIG. 13 is a flowchart of an embodiment of a video keno routine that may be performed by one or more of the gaming units;

FIG. 14 is an illustration of an embodiment of a visual display that may be displayed during performance of the video bingo routine of FIG. 15;

FIG. 15 is a flowchart of an embodiment of a video bingo routine that may be performed by one or more of the gaming units; and

FIG. 16 is a flowchart of an embodiment of a operational event recording routine that may be performed by one or more of the gaming units.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

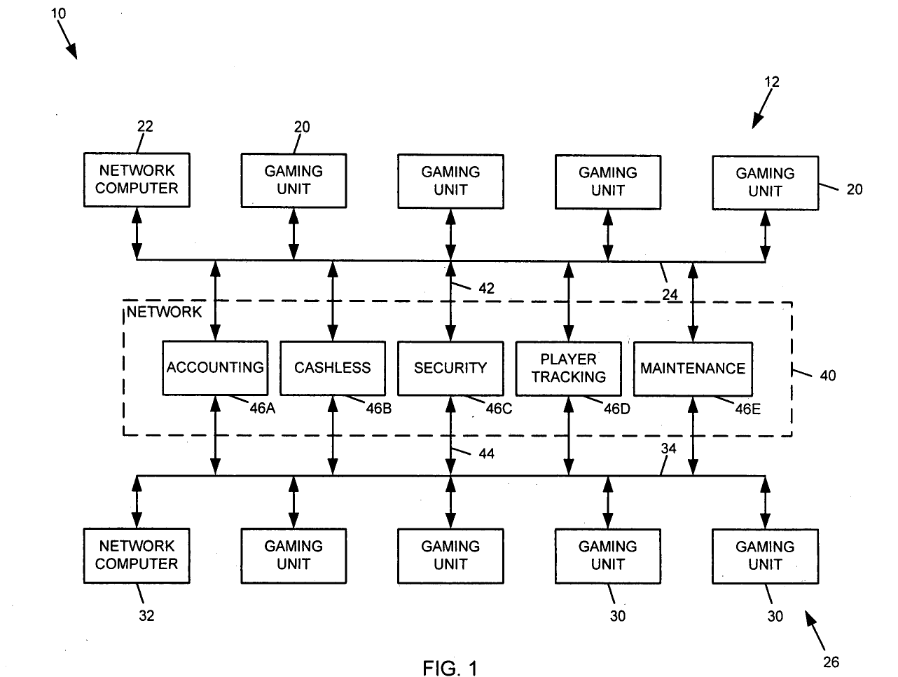

FIG. 1 illustrates one possible embodiment of a casino gaming system 10 in accordance with the invention. Referring to FIG. 1, the casino gaming system 10 may include a first group or network 12 of casino gaming units 20 operatively coupled to a network computer 22 via a network data link or bus 24. The casino gaming system 10 may include a second group or network 26 of casino gaming units 30 operatively coupled to a network computer 32 via a network data link or bus 34. The first and second gaming networks 12, 26 may be operatively coupled to each other via a network 40, which may comprise, for example, the Internet, a wide area network (WAN), or a local area network (LAN) via a first network link 42 and a second network link 44.

The first network 12 of gaming units 20 may be provided in a first casino, and the second network 26 of gaming units 30 may be provided in a second casino located in a separate geographic location than the first casino. For example, the two casinos may be located in different areas of the same city, or they may be located in different states. Where the network 40 comprises the Internet, data communication may take place over the communication links 42, 44 via an Internet communication protocol. The network 40 may include a plurality of network computers or server computers, each of which may be operatively interconnected with the first and second networks 12, 26.

The network computers and/or server computers within the network 40 may be used to gather particular types of operational event data from the network computers 22, 32. For example, the server computers may include an accounting server 46A, a cashless server 46B, a security server 46C, a player tracking server 46D and a maintenance server 46E. Operational event data may be collected for all operational events that occur on the gaming unit 20. The network computer 22 may collect the operational event data relating to any and all events that occur with the gaming units 20, 30 on the networks 12, 26. Each of the server computers 46A-46E may collect particular types of operational event data from each of the network computers 22, 32. For example, the accounting server 46A may collect accounting data from each of the gaming units via the network computers 22, 32. Likewise, the cashless server 46B may collect cashless data (e.g., ticket voucher information), the security server 46C may collect security data, the player tracking server 46D may collect player tracking data and the maintenance server 46E may collect maintenance data. Each type of operational event data may be collected by the server computers 46A-46E on demand or periodically (e.g., every hour, every day, every week, etc.).

Accounting data may include the number of coins received by the gaming unit 20 which may be organized by denomination, the number of bills received by the gaming unit 20 which may be organized by denomination, the total amount of wagers received by the gaming unit 20 which may be organized by denomination, the number of wagers made, the number of games played, the number of players who have played on the gaming unit 20, jackpots that have been won on the gaming unit, payouts made by the gaming unit 20, the amount of each jackpot and payout, etc. Cashless data may include information relating to each ticket voucher issued by the gaming unit 20 relating to cash in/out of the gaming unit 20, which may be the same information printed on a cash-redemption ticket voucher. The ticket voucher information may relate to a player's single sitting at the gaming unit 20, which may include the total number of games played by the player, the total amount won or lost by the player, the total amount wagered by the player, total payouts determined from the player's wagers, wagers separate by denomination (e.g., $5, $10, $20), payouts separated by denomination, coins inputted by the player, bills inputted by the player, machine identification, casino identification, player identification, date and time of the payout determinations and/or issuance of the ticket voucher, jackpots won by the player, etc. Security data may relate to security events that occur with the gaming unit 20 including someone accessing the gaming unit 20 (electronically or physically), opening of the gaming unit 20, removal of cash from the gaming unit 20, errors, etc. Security data may further relate to the security and integrity of programs executed on the gaming unit 20. When a program is first loaded or installed on a gaming unit 20, network computer 22, etc., an image of the program may be taken and stored as security data. The program image may be compared with the program at a later time to determine the integrity of the program. Any differences between the program image and the program may indicate that the program has been compromised (e.g., has the program been rewritten or replaced without authorization). The program may also be associated with a digital signature associated only with the original program. The digital signature may be copied and stored as security data for later comparison to prove the program is the same as the one that was originally installed/loaded. Player tracking data may include the identity and gaming habits of the player such as how much the player has wagered and won (which may include multiple sittings at the gaming unit 20), games played, etc. Maintenance data may include data relating to cashbox status (e.g., cashbox full, cashbox empty), coin hopper status (e.g., hopper full, hopper empty), machine tilt, etc. Each type of operational event data may include a date, time and gaming unit 20 identification associated with the operational event.

The network computer 22 may be a server computer and may be used to accumulate and analyze data relating to and intrinsic to the operations and events of the gaming units 20. For example, the network computer 22 may continuously receive operational event data described above from each of the gaming units 20 indicative of the dollar amount and number of wagers being made on each of the gaming units 20, data indicative of how much each of the gaming units 20 is paying out in winnings, data regarding the identity and gaming habits of players playing each of the gaming units 20, etc. The network computer 32 may be a server computer and may be used to perform the same or different functions in relation to the gaming units 30 as the network computer 22 described above. Each of the network computers 22, 32 may collect operational event data from the gaming units 20, 30 within a local area network (LAN) and provide this data to one or more of the server computers 46A-46E, though the operational event data may also be collected by one or more of the gaming units 20. The operational event data may be provided to the central computers 46A-46E continuously, periodically or upon a request from the central computer. The operational event data may also be shared among the network computers 22, 32 or shared among the gaming units 20 to provide redundant (mirrored) storage at different locations. The network computers 22, 32, may also back up the server computers 46A-46E. If one of the server computers 46A-46E fails, the network computers 22, 32, may continue to operate the gaming system 10. If one of the network computers 22, 32 fail, one or more of the remaining network computers may function on behalf of the failed network computer.

Although each network 12, 26 is shown to include one network computer 22, 32 and four gaming units 20, 30, it should be understood that different numbers of computers and gaming units may be utilized. For example, the network 12 may include a plurality of network computers 22 and tens or hundreds of gaming units 20, all of which may be interconnected via the data link 24. The data link 24 may be provided as a dedicated hardwired link or a wireless link. Although the data link 24 is shown as a single data link 24, the data link 24 may comprise multiple data links.

The casino gaming system 10 described above may be equally applicable to a government-sponsored lottery system. Government-sponsored lottery systems may refer to a network of interactive lottery units similar to the network 12 of gaming units 20 described above. In this example, each stand-alone gaming unit 20, 30 may act as an interactive lottery unit capable of playing a variety of casino game such as a lottery game, keno, video poker, video blackjack, video bingo, slots, etc. The operational event data may be sent to lottery server computers similar to the server computers 46A-46E described above, or remain :with the network computers 22, 32, which may analyze the operational event data.

The system 10 illustrated in FIG. 1 may represent the network layout of a government-sponsored establishment providing a lottery-type game. The lottery units may be distributed throughout an establishment and connected with a LAN, or throughout multiple establishments and connected with a WAN. Further, the LAN and/or WAN connected each of the lottery units may include one or more separate and secure buses, routers, gateways and other networking equipment to provide continuous and/or redundant connectivity to the network. The network, configured in this manner, provides a system for players to collectively participate in a centralized lottery, keno, poker, blackjack, bingo or slots game. This may involve competitive participation or passive participation. A lottery-type game may refer to game with a predetermined number of wins where only a predetermined number of wagers may result in a payout. The predetermined number of wins may refer to value payouts greater than a predetermined amount, whereas smaller value payouts do not count towards the predetermined number of wins. For example, in a given day the central lottery server of a government-sponsored lottery-type game may permit a total of only 5 wins out of 100 lottery units. A lottery-type game may also pay winning wagers from a limited payout pool, which may be shared equally among all winning wagers. The payout pool may be a set amount of money or a progressive value payout that continues to grow as more wagers are made. Generally, only a predetermined number of wins may be permitted within a given period of time, within a given number of wagers, within a given number of players or lottery units, etc. Casino games, on the other hand, may permit an unlimited number of wins creating the possibility that every wager may result in a win.

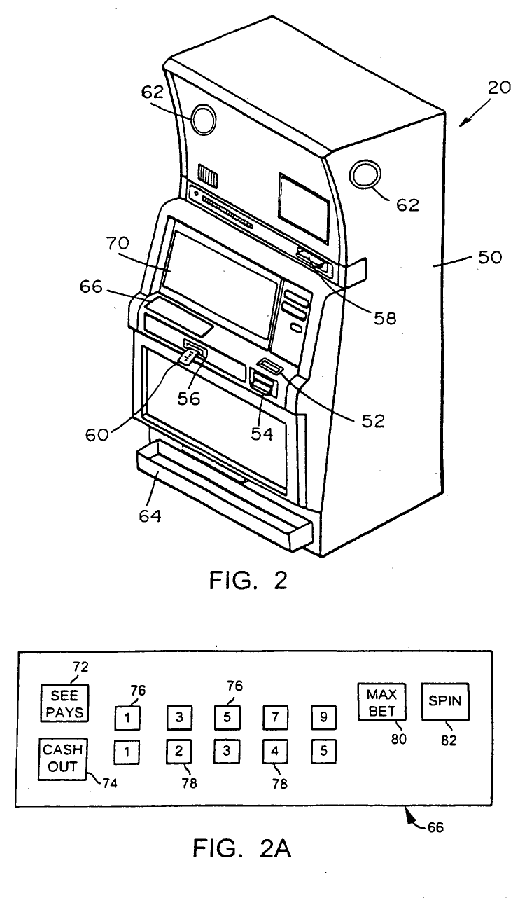

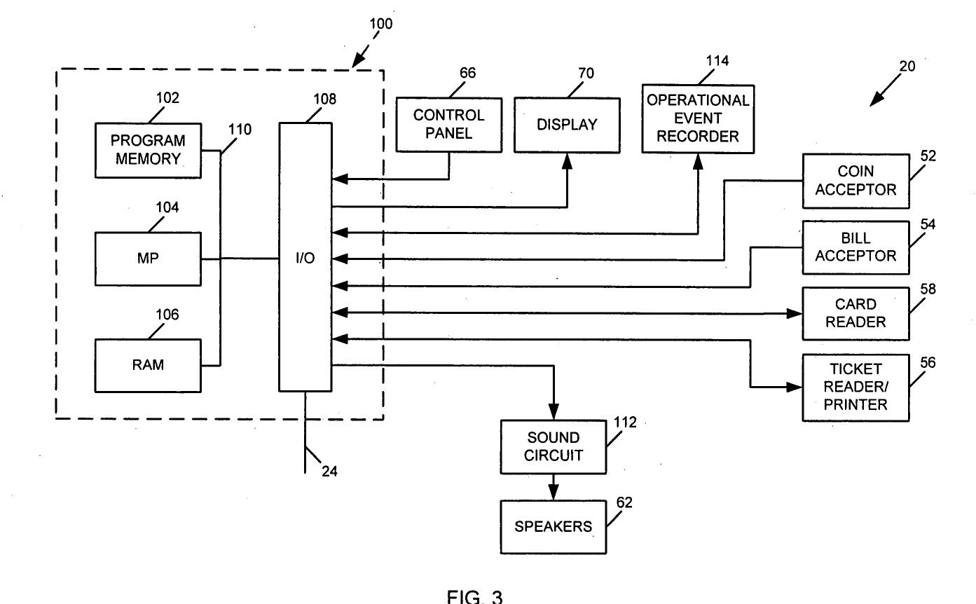

FIG. 2 is a perspective view of one possible embodiment of one or more of the gaming units 20. Although the following description addresses the design of the gaming units 20, it should be understood that the gaming units 30 and the lottery units may have the same design as the gaming units 20 described below. It should be understood that the design of one or more of the gaming units 20 may be different than the design of other gaming units 20, the design of one or more of the gaming units 30 may be different than the design of other gaming units 30, and that the design of one or more of the lottery units may be different than the design of other lottery units. Each gaming unit 20 may be any type of casino gaming unit or lottery unit and may have various different structures and methods of operation. For exemplary purposes, various designs of the gaming units 20 are described below, but it should be understood that numerous other designs may be utilized.

Referring to FIG. 2, the casino gaming unit 20 may include a housing or cabinet 50 and one or more input devices, which may include a coin slot or acceptor 52, a paper currency acceptor 54, a ticket reader/printer 56 and a card reader 58, which may be used to input value to the gaming unit 20. A value input device may include any device that can accept value from a customer. As used herein, the term “value” may encompass gaming tokens, coins, paper currency, ticket vouchers, credit or debit cards, smart cards, and any other object representative of value.

If provided on the gaming unit 20, the ticket reader/printer 56 may be used to read and/or print or otherwise encode ticket vouchers 60. The ticket vouchers 60 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable including the information described above for a ticket voucher. A ticket voucher 60 issued by a gaming unit 20 may also include a variety of information relating to operational event data relating to the player and/or the gaming unit 20, including the number of games played, amounts won or lost, amount wagers, particular denominations used to place wagers, gaming unit 20 identification casino identification, time and date of issuance, time and date of the wager(s), etc. For security purposes, the ticket voucher 60 may be encoded or printed with player identification, which may simply be the player's name or signature, but could also be an encrypted code representative of the player's identity. In one example, the player's signature may have previously been scanned and converted to a code. When the player redeems the ticket voucher 60, the player may be required to produce identification. The code may be decrypted and compared to the player's identification (e.g., signature, photo identification, etc.).

Different types of ticket vouchers 60 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 60 could be printed with an optically readable material such as ink, or data on the ticket vouchers 60 could be magnetically encoded. The ticket reader/printer 56 may be provided with the ability to both read and print ticket vouchers 60, or it may be provided with the ability to only read or only print or encode ticket vouchers 60. In the latter case, for example, some of the gaming units 20 may have ticket printers 56 that may be used to print ticket vouchers 60, which could then be used by a player in other gaming units 20 that have ticket readers 56.

If provided, the card reader 58 may include any type of card reading device, such as a magnetic card reader or an optical card reader, and may be used to read data from a card offered by a player, such as a credit card or a player tracking card. If provided for player tracking purposes, the card reader 58 may be used to read data from, and/or write data to, player tracking cards that are capable of storing data representing the identity of a player, the identity of a casino, the player's gaming habits, etc.

The gaming unit 20 may include one or more audio speakers 62, a coin payout tray 64, an input control panel 66, and a display unit 70. Where the gaming unit 20 is designed to facilitate play of a video casino game, such as video poker or video slots, the display unit 70 may be a color video display unit that displays images relating to the particular game or games. Where the gaming unit 20 is designed to facilitate play of a reel-type slot machine, the display unit 70 may comprise a plurality of mechanical reels that are rotatable, with each of the reels having a plurality of reel images disposed thereon. The audio speakers 62 may generate audio representing sounds such as the noise of spinning slot machine reels, a dealer's voice, music, announcements or any other audio related to a casino game. The input control panel 66 may be provided with a plurality of pushbuttons or touch-sensitive areas that may be pressed by a player to select games, make wagers, make gaming decisions, etc.

FIG. 2A illustrates one possible embodiment of the control panel 66, which may be used where the gaming unit 20 is a slot machine having a plurality of mechanical or “virtual” reels. Referring to FIG. 2A, if the display unit 70 is provided in the form of a video display unit, the control panel 66 may include a “See Pays” button 72 that, when activated, causes the display unit 70 to generate one or more display screens showing the odds or payout information for the game or games provided by the gaming unit 20. As used herein, the term “button” is intended to encompass any device that allows a player to make an input, such as an input device that must be depressed to make an input selection or a display area that a player may simply touch. The control panel 66 may include a “Cash Out” button 74 that may be activated when a player decides to terminate play on the gaming unit 20, in which case the gaming unit 20 may return value to the player, such as by returning a number of coins to the player via the payout tray 64.

If the gaming unit 20 provides a slots game having a plurality of reels and a plurality of paylines which define winning combinations of reel symbols, the control panel 66 may be provided with a plurality of selection buttons 76, each of which allows the player to select a different number of paylines prior to spinning the reels. For example, five buttons 76 may be provided, each of which may allow a player to select one, three, five, seven or nine paylines.

If the gaming unit 20 provides a slots game having a plurality of reels, the control panel 66 may be provided with a plurality of selection buttons 78 each of which allows a player to specify a wager amount for each payline selected. For example, if the smallest wager accepted by the gaming unit 20 is a quarter ($0.25), the gaming unit 20 may be provided with five selection buttons 78, each of which may allow a player to select one, two, three, four or five quarters to wager for each payline selected. In that case, if a player were to activate the “5” button 76 (meaning that five paylines were to be played on the next spin of the reels) and then activate the “3” button 78 (meaning that three coins per payline were to be wagered), the total wager would be $3.75 (assuming the minimum bet was $0.25).

The control panel 66 may include a “Max Bet” button 80 to allow a player to make the maximum wager allowable for a game. In the above example, where up to nine paylines were provided and up to five quarters could be wagered for each payline selected, the maximum wager would be 45 quarters, or $11.25. The control panel 66 may include a spin button 82 to allow the player to initiate spinning of the reels of a slots game after a wager has been made.

In FIG. 2A, a rectangle is shown around the buttons 72, 74, 76, 78, 80, 82. It should be understood that that rectangle simply designates, for ease of reference, an area in which the buttons 72, 74, 76, 78, 80, 82 may be located. Consequently, the term “control panel” should not be construed to imply that a panel or plate separate from the housing 50 of the gaming unit 20 is required, and the term “control panel” may encompass a plurality or grouping of player activatable buttons.

Although one possible control panel 66 is described above, it should be understood that different buttons could be utilized in the control panel 66, and that the particular buttons used may depend on the game or games that could be played on the gaming unit 20. If the display unit 70 is provided as a video display unit, the control panel 66 could be generated by the display unit 70. In that case, each of the buttons of the control panel 66 could be a colored area generated by the display unit 70, and some type of mechanism may be associated with the display unit 70 to detect when each of the buttons was touched, such as a touch-sensitive screen.

### Gaming Unit Electronics

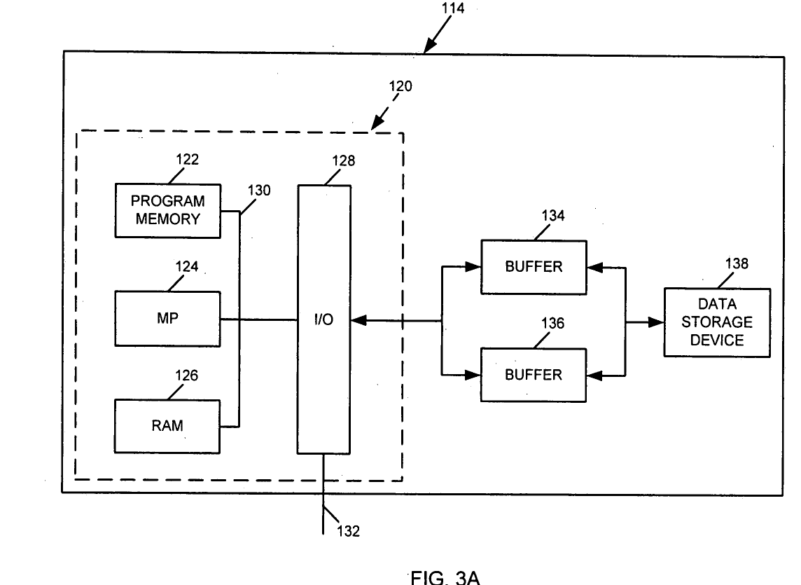

FIG. 3 is a block diagram of a number of components that may be incorporated in the gaming unit 20. Referring to FIG. 3, the gaming unit 20 may include a controller 100 that may comprise a program memory 102, a microcontroller or microprocessor (MP) 104, a random-access memory (RAM) 106 and an input/output (I/O) circuit 108, all of which may be interconnected via an address/data bus 110. It should be appreciated that although only one microprocessor 104 is shown, the controller 100 may include multiple microprocessors 104. Similarly, the memory of the controller 100 may include multiple RAMs 106 and multiple program memories 102. The RAM 106 may be non-volatile program memory that temporarily stores operational event data on a first in, first out (FIFO) basis. Although the I/O circuit 108 is shown as a single block, it should be appreciated that the I/O circuit 108 may include a number of different types of I/O circuits. The RAM(s) 104 and program memories 102 may be implemented as semiconductor memories, magnetically readable memories, and/or optically readable memories, for example.

Although the program memory 102 is shown in FIG. 3 as a read-only memory (ROM) 102, the program memory of the controller 100 may be a read/write or alterable memory, such as a hard disk. In the event a hard disk is used as a program memory, the address/data bus 110 shown schematically in FIG. 3 may comprise multiple address/data buses, which may be of different types, and there may be an I/O circuit disposed between the address/data buses.

FIG. 3 illustrates that the control panel 66, the coin acceptor 52, the bill acceptor 54, the card reader 58 and the ticket reader/printer 56 may be operatively coupled to the I/O circuit 108, each of those components being so coupled by either a unidirectional or bidirectional, single-line or multiple-line data link, which may depend on the design of the component that is used. The speaker(s) 62 may be operatively coupled to a sound circuit 112, that may comprise a voice- and sound-synthesis circuit or that may comprise a driver circuit. The sound-generating circuit 112 may be coupled to the I/O circuit 108. An operational event recorder 114 may be operatively coupled to the I/O circuit 108 with a unidirectional or bidirectional, single line or multiple-line link. The operational event recorder 114 may be utilized to retrieve operational event data from the gaming unit 20 which may be temporarily stored in the RAM 106.

As shown in FIG. 3, the components 52, 54, 56, 58, 66, 112, 114 may be connected to the I/O circuit 108 via a respective direct line or conductor. Different connection schemes could be used. For example, one or more of the components shown in FIG. 3 may be connected to the I/O circuit 108 via a common bus or other data link that is shared by a number of components. Furthermore, some of the components may be directly connected to the microprocessor 104 without passing through the I/O circuit 108. The gaming unit 20 may further include several sensors (not shown) operatively coupled to the controller 100 that monitor operational events on the gaming unit 20. For example, the housing 50 may include a sensor to detect the opening of the housing 50 which may be considered a security event. The sensor may transmit a signal to the controller 100 which may associate a timestamp with the security event. The security event and associated timestamp may be temporarily stored in the memory of the controller 100 as operational event data. Additional sensors may be provided in the card reader 58 to provide player tracking data, the coin acceptor 52 and bill acceptor 54 for accounting data, the ticket reader/printer 56 to provide cashless data, the coin hopper and cashbox to provide maintenance data, etc. Operational event data of a particular type may be provided by sensors in more than one of the components 52, 54, 56, 58, 66, 112, 114. For example, player tracking data may be provided from sensors in the control panel 66 to detect player selections, in addition to the card reader 58.

FIG. 3A is a block diagram of the operational event recorder 114. Referring to FIG. 3A, the operational event recorder 114 may comprise a operational event controller 120. The operational event controller 120 may comprise a program memory 122, a microcontroller or microprocessor (MP) 124, a random-access memory (RAM) 126 and an input/output (I/O) circuit 128, all of which may be interconnected via an address/data bus 130. A network data link or bus 132 may operatively couple the I/O circuit 128, and hence the operational event recorder 114 to the gaming unit controller 100 and/or the network 12. It should be appreciated that although only one microprocessor 124 is shown, the operational event controller 120 may include multiple microprocessors 124. Similarly, the memory of the operational event controller 120 may include multiple RAMs 126 and multiple program memories 122. The RAM 126 may be non-volatile memory.

The operational event recorder 114 may further include one or more memory buffers 134, 136 and a data storage device 138 operatively coupled to the operational event controller 120 via the I/O circuit 128. The memory buffers 134, 136 may be provided in addition to or as an alternative to the RAM 126. The memory buffers 134, 136 may be non-volatile memory to temporarily store the operational event data. When the first memory buffer 134 is full, the operational event data may be written to the data storage device 138. During the writing operation, the second memory buffer 136 may continue to receive the operational event data.

The data storage device 138 may be a single-write data storage device which may be an optical diskdrive with a writable optical disk, a magnetic disk drive with a magnetic disk, a solid-state memory device, a hard drive, or any other device which may be written with data once, but not alterable or erasable once the data is written (i.e., write-once, read-only). The writable optical disk and magnetic disk may be removable from the optical disk drive and the magnetic disk drive, respectively, when full. The disks may then be replaced with other disks and the original disk may be stored in a secure location. However, it is possible that the capacity of the disks allow operational event data for the life of a gaming unit 20 to be recorded without replacing the disk. In one embodiment, the writable optical disk and magnetic disk may be compressed to hold more operational event data. If DVD-RW, CD-RW or other re-writable disks are used, the operational event data may be protected with encryption to prevent alteration or erasure and to prevent unauthorized access to effectively cause the re-writable disk to be a single-write data storage device. Encryption may also be used in conjunction with write-once, read only devices such as CD-R and DVD-R. Additionally, digital watermarks may be randomly written into the operational event data when being written to the data storage device 138 to determine whether the data has been altered. The data storage device 138 may be securely stored within the housing 50 of the gaming unit 20 or within the housing of the network computer 22 to prevent unauthorized access.

The operational event recorder 114 may be incorporated in each gaming unit 20 on the network 12 or in only one or a few gaming units 20 on the network 12. If the operational event recorder 114 is incorporated in only one or a few gaming units 20 on the network 12, the operational event controller 114 may remain operatively coupled to the controllers 100 of the remaining gaming units 20 to receive operational event data from all gaming units 20 on the network 12. The operational event recorder 114 may also be incorporated in the network computer 22 which may receive operational event data from all gaming units 20 on the network 12. If the operational event recorder 114 is incorporated in the network computer 22, the operational event data may be copied to other operational event recorders 114 in the remaining network computers 32. Multiple operational event recorders 114 may be incorporated in a single device (e.g., multiple operational event recorders 114 in a single gaming unit 20, etc.). Although the operational event recorder 114 is described above as being operatively coupled to the gaming unit controller 100, it will be recognized that the controller 100 may function as the operational event controller 120, in which case the controller 100 may be operatively coupled to the memory buffers 134, 136 and the data storage device 138, though the RAM 106 may function as the memory buffers 134, 136.

### Overall Operation of Gaming Unit

One manner in which one or more of the gaming units 20 (and one or more of the gaming units 30) may operate is described below in connection with a number of flowcharts which represent a number of portions or routines of one or more computer programs, which may be stored in one or more of the memories of the controller 100. The computer program(s) or portions thereof may be stored remotely, outside of the gaming unit 20, and may control the operation of the gaming unit 20 from a remote location. Such remote control may be facilitated with the use of a wireless connection, or by an Internet interface that connects the gaming unit 20 with a remote computer (such as one of the network computers 22, 32) having a memory in which the computer program portions are stored. The computer program portions may be written in any high level language such as C, C++, C#, Java or the like or any low-level assembly or machine language. By storing the computer program portions therein, various portions of the memories 102, 106 are physically and/or structurally configured in accordance with computer program instructions.

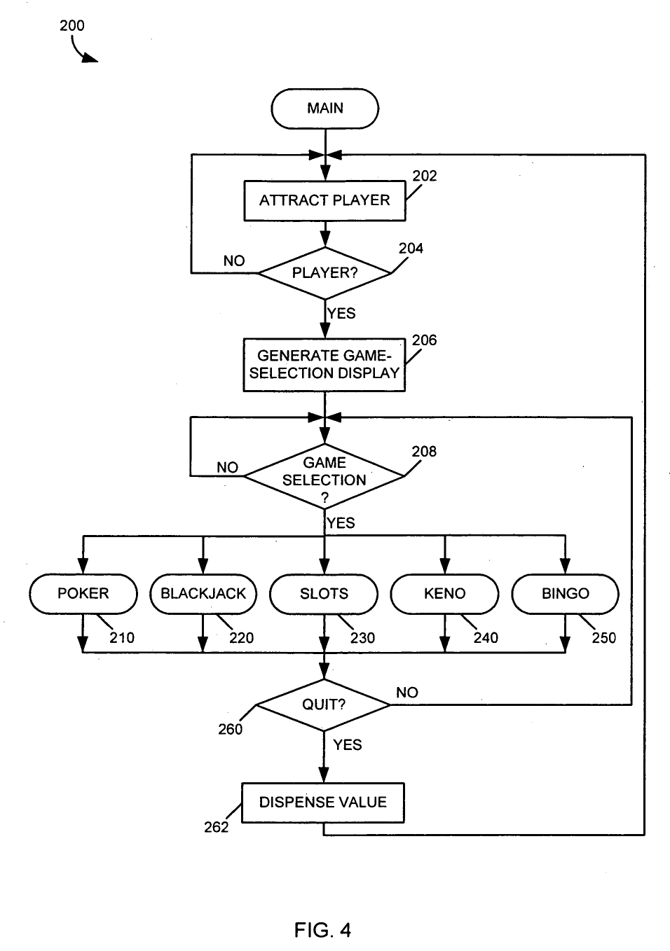

FIG. 4 is a flowchart of a main operating routine 200 that may be stored in the memory of the controller 100. Referring to FIG. 4, the main routine 200 may begin operation at block 202 during which an attraction sequence may be performed in an attempt to induce a potential player in a casino to play the gaming unit 20. The attraction sequence may be performed by displaying one or more video images on the display unit 70 (if provided as a video display unit) and/or causing one or more sound segments, such as voice or music, to be generated via the speakers 62. The attraction sequence may include a scrolling list of games that may be played on the gaming unit 20 and/or video images of various games being played, such as video poker, video blackjack, video slots, video keno, video bingo, etc.

During performance of the attraction sequence, if a potential player makes any input to the gaming unit 20 as determined at block 204, the attraction sequence may be terminated and a game-selection display may be generated on the display unit 70 (if provided as a video display unit) at block 206 to allow the player to select a game available on the gaming unit 20. The gaming unit 20 may detect an input at block 204 in various ways. For example, the gaming unit 20 could detect if the player presses any button on the gaming unit 20; the gaming unit 20 could determine if the player deposited one or more coins into the gaming unit 20; the gaming unit 20 could determine if the player deposited paper currency into the gaming unit; etc.

The game-selection display generated at block 206 may include, for example, a list of video games that may be played on the gaming unit 20 and/or a visual message to prompt the player to deposit value into the gaming unit 20. While the game-selection display is generated, the gaming unit 20 may wait for the player to make a game selection. Upon selection of one of the games by the player as determined at block 208, the controller 100 may cause one of a number of game routines to be performed to allow the selected game to be played. For example, the game routines could include a video poker routine 210, a video blackjack routine 220, a slots routine 230, a video keno routine 240, and a video bingo routine 250. At block 208, if no game selection is made within a given period of time, the operation may branch back to block 202.

After one of the routines 210, 220, 230, 240, 250 has been performed to allow the player to play one of the games, block 260 may be utilized to determine whether the player wishes to terminate play on the gaming unit 20 or to select another game. If the player wishes to stop playing the gaming unit 20, which wish may be expressed, for example, by selecting a “Cash Out” button, the controller 100 may dispense value to the player at block 262 based on the outcome of the game(s) played by the player. The dispensation at block 262 may include storing the data in the memory of the controller 100 as operational event data, along with the date, time, gaming unit identification, player identification, payout amount, etc. The operation may then return to block 202. If the player did not wish to quit as determined at block 260, the routine may return to block 208 where the game-selection display may again be generated to allow the player to select another game.

It should be noted that although five gaming routines are shown in FIG. 4, a different number of routines could be included to allow play of a different number of games. The gaming unit 20 may also be programmed to allow play of different games.

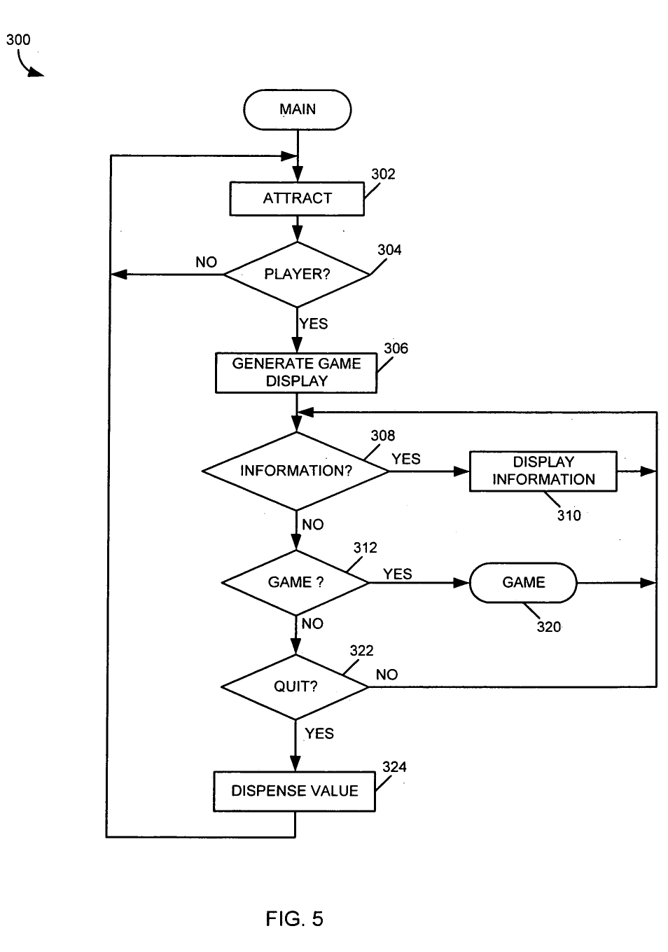

FIG. 5 is a flowchart of an alternative main operating routine 300 that may be stored in the memory of the controller 100. The main routine 300 may be utilized for gaming units 20 that are designed to allow play of only a single game or single type of game. Referring to FIG. 5, the main routine 300 may begin operation at block 302 during which an attraction sequence may be performed in an attempt to induce a potential player in a casino to play the gaming unit 20. The attraction sequence may be performed by displaying one or more video images on the display unit 70 (if provided as a video display unit) and/or causing one or more sound segments, such as voice or music, to be generated via the speakers 62.

During performance of the attraction sequence, if a potential player makes any input to the gaming unit 20 as determined at block 304, the attraction sequence may be terminated and a game display may be generated on the display unit 70 (if provided as a video display unit) at block 306. The game display generated at block 306 may include, for example, an image of the casino game that may be played on the gaming unit 20 and/or a visual message to prompt the player to deposit value into the gaming unit 20. At block 308, the gaming unit 20 may determine if the player requested information concerning the game, in which case the requested information may be displayed at block 310. Block 312 may be used to determine if the player requested initiation of a game, in which case a game routine 320 may be performed. The game routine 320 could be any one of the game routines disclosed herein, such as one of the five game routines 210, 220, 230, 240, 250, or another game routine.

After the routine 320 has been performed to allow the player to play the game, block 322 may be utilized to determine whether the player wishes to terminate play on the gaming unit 20. If the player wishes to stop playing the gaming unit 20, which wish may be expressed, for example, by selecting a “Cash Out” button, the controller 100 may dispense value to the player at block 324 based on the outcome of the game(s) played by the player and store the operational event data in the memory of the controller 100. The operation may then return to block 302. If the player did not wish to quit as determined at block 322, the operation may return to block 308.

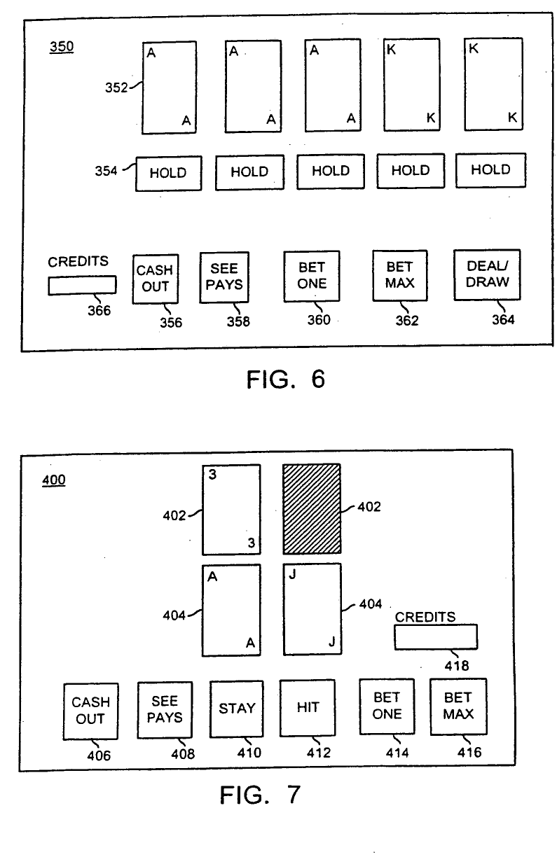

### Video Poker

Where the gaming unit 20 is designed to facilitate play of a video poker game, the display unit 70 may comprise a video display unit. FIG. 6 is an exemplary display 350 that may be shown on the display unit 70 during performance of the video poker routine 210 shown schematically in FIG. 4. Referring to FIG. 6, the display 350 may include video images 352 of a plurality of playing cards representing the player's hand, such as five cards. To allow the player to control the play of the video poker game, a plurality of player-selectable buttons may be displayed. The buttons may include a “Hold” button 354 disposed directly below each of the playing card images 352, a “Cash Out” button 356, a “See Pays” button 358, a “Bet One Credit” button 360, a “Bet Max Credits” button 362, and a “Deal/Draw” button 364. The display 350 may also include an area 366 in which the number of remaining credits or value is displayed. If the display unit 70 is provided with a touch-sensitive screen, the buttons 354, 356, 358, 360, 362, 364 may form part of the video display 350. Alternatively, one or more of those buttons may be provided as part of a control panel that is provided separately from the display unit 70.

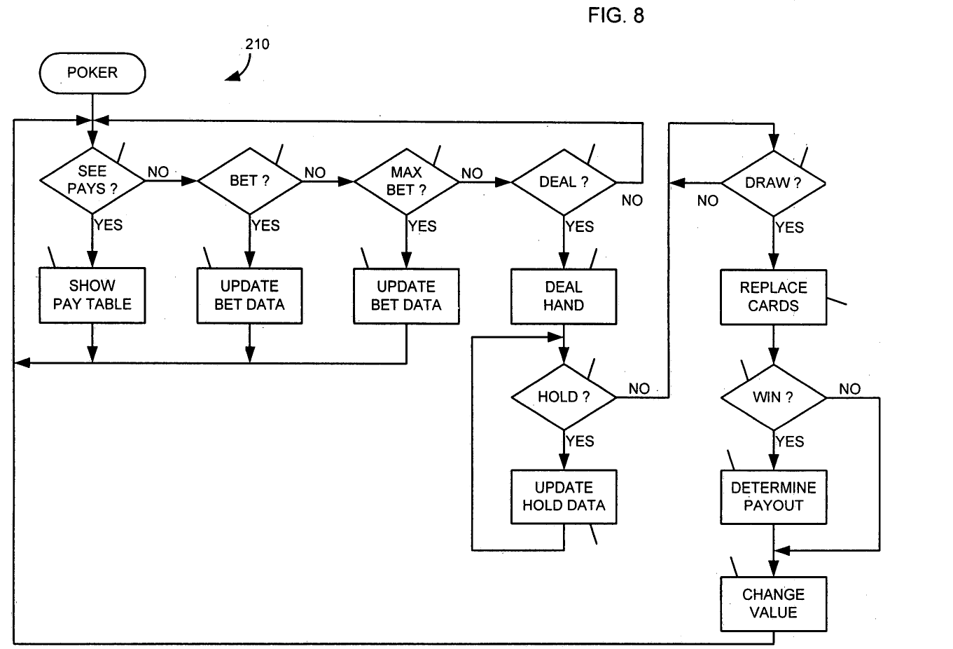

FIG. 8 is a flowchart of the video poker routine 210 shown schematically in FIG. 4. Referring to FIG. 8, at block 370, the routine may determine whether the player has requested payout information, such as by activating the “See Pays” button 358, in which case at block 372 the routine may cause one or more pay tables to be displayed on the display unit 70. At block 374, the routine may determine whether the player has made a bet,-such as by pressing the “Bet One Credit” button 360, in which case at block 376 bet data corresponding to the bet made by the player may be stored in the memory of the controller 100 as operational event data, along with the date, time, gaming unit identification, player identification, bet amount, total bet amount, etc. At block 378, the routine may determine whether the player has pressed the “Bet Max Credits” button 362, in which case at block 380 bet data corresponding to the maximum allowable bet may be stored in the memory of the controller 100 which may also be stored as operational event data.

At block 382, the routine may determine if the player desires a new hand to be dealt, which may be determined by detecting if the “Deal/Draw” button 364 was activated after a wager was made. In that case, at block 384 a video poker hand may be “dealt” by causing the display unit 70 to generate the playing card images 352. After the hand is dealt, at block 386 the routine may determine if any of the “Hold” buttons 354 have been activated by the player, in which case data regarding which of the playing card images 352 are to be “held” may be stored in the controller 100 at block 388. If the “Deal/Draw” button 364 is activated again as determined at block 390, each of the playing card images 352 that was not “held” may be caused to disappear from the video display 350 and to be replaced by a new, randomly selected, playing card image 352 at block 392.

At block 394, the routine may determine whether the poker hand represented by the playing card images 352 currently displayed is a winner. That determination may be made by comparing data representing the currently displayed poker hand with data representing all possible winning hands, which may be stored in the memory of the controller 100 as operational event data. If there is a winning hand, a payout value corresponding to the winning hand may be determined at block 396. At block 398, the player's cumulative value or number of credits may be updated by subtracting the bet made by the player and adding, if the hand was a winner, the payout value determined at block 396. The cumulative value or number of credits may also be displayed in the display area 366 (FIG. 6) and stored in the memory of the controller 100 as operational event data.

Although the video poker routine 210 is described above in connection with a single poker hand of five cards, the routine 210 may be modified to allow other versions of poker to be played. For example, seven card poker may be played, or stud poker may be played. Alternatively, multiple poker hands may be simultaneously played. In that case, the game may begin by dealing a single poker hand, and the player may be allowed to hold certain cards. After deciding which cards to hold, the held cards may be duplicated in a plurality of different poker hands, with the remaining cards for each of those poker hands being randomly determined.

### Video Blackjack

Where the gaming unit 20 is designed to facilitate play of a video blackjack game, the display unit 70 may comprise a video display unit. FIG. 7 is an exemplary display 400 that may be shown on the display unit 70 during performance of the video blackjack routine 220 shown schematically in FIG. 4. Referring to FIG. 7, the display 400 may include video images 402 of a pair of playing cards representing a dealer's hand, with one of the cards shown face up and the other card being shown face down, and video images 404 of a pair of playing cards representing a player's hand, with both the cards shown face up. The “dealer” may be the gaming unit 20.

To allow the player to control the play of the video blackjack game, a plurality of player-selectable buttons may be displayed. The buttons may include a “Cash Out” button 406, a “See Pays” button 408, a “Stay” button 410, a “Hit” button 412, a “Bet One Credit” button 414, and a “Bet Max Credits” button 416. The display 400 may also include an area 418 in which the number of remaining credits or value is displayed. If the display unit 70 is provided with a touch-sensitive screen, the buttons 406, 408, 410, 412, 414, 416 may form part of the video display 400. Alternatively, one or more of those buttons may be provided as part of a control panel that is provided separately from the display unit 70.

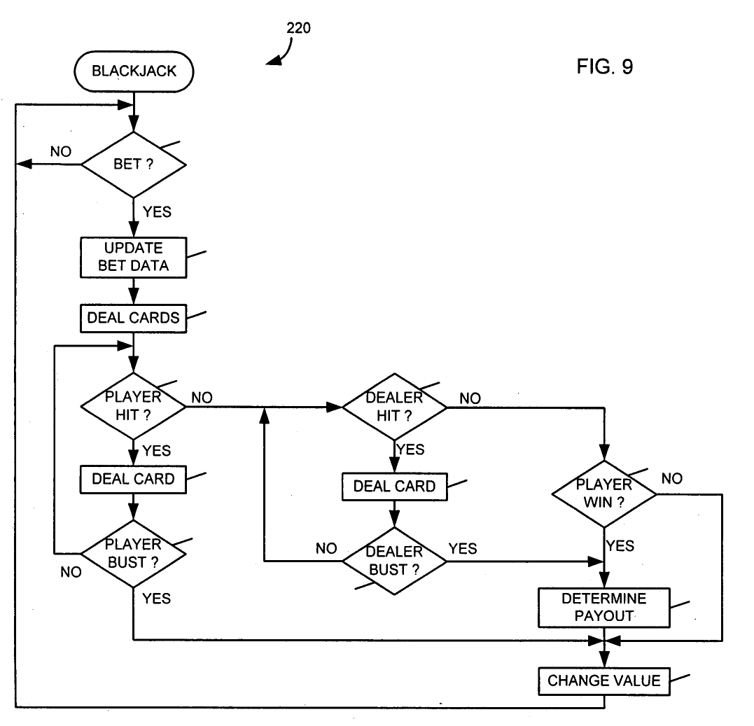

FIG. 9 is a flowchart of the video blackjack routine 220 shown schematically in FIG. 4. Referring to FIG. 9, the video blackjack routine 220 may begin at block 420 where it may determine whether a bet has been made by the player. That may be determined, for example, by detecting the activation of either the “Bet One Credit” button 414 or the “Bet Max Credits” button 416. At block 422, bet data corresponding to the bet made at block 420 may be stored in the memory of the controller 100 as operational event data. At block 424, a dealer's hand and a player's hand may be “dealt” by making the playing card images 402, 404 appear on the display unit 70.

At block 426, the player may be allowed to be “hit,” in which case at block 428 another card will be dealt to the player's hand by making another playing card image 404 appear in the display 400. If the player is hit, block 430 may determine if the player has “bust,” or exceeded 21. If the player has not bust, blocks 426 and 428 may be performed again to allow the player to be hit again.

If the player decides not to hit, at block 432 the routine may determine whether the dealer should be hit. Whether the dealer hits may be determined in accordance with predetermined rules, such as the dealer always hit if the dealer's hand totals 15 or less. If the dealer hits, at block 434 the dealer's hand may be dealt another card by making another playing card image 402 appear in the display 400. At block 436 the routine may determine whether the dealer has bust. If the dealer has not bust, blocks 432, 434 may be performed again to allow the dealer to be hit again.

If the dealer does not hit, at block 436 the outcome of the blackjack game and a corresponding payout may be determined based on, for example, whether the player or the dealer has the higher hand that does not exceed 21. The outcome and payout may be stored in the memory of the controller 100 as operational event data. If the player has a winning hand, a payout value corresponding to the winning hand may be determined at block 440. At block 442, the player's cumulative value or number of credits may be updated by subtracting the bet made by the player and adding, if the player won, the payout value determined at block 440. The cumulative value or number of credits may also be displayed in the display area 418 (FIG. 7) and stored in the memory of the controller 100 as operational event data.

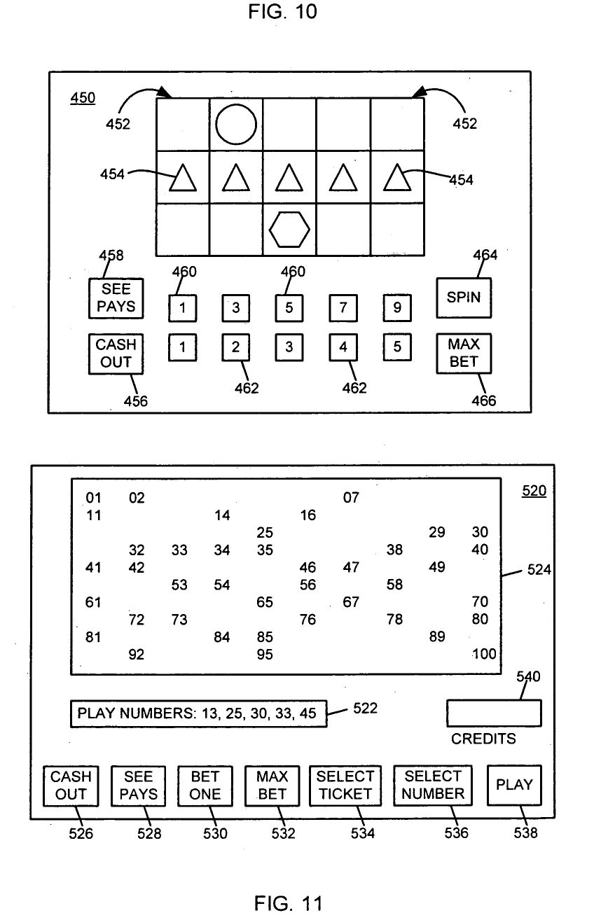

### Slots

Where the gaming unit 20 is designed to facilitate play of a video slots game, the display unit 70 may comprise a video display unit. FIG. 10 is an exemplary display 450 that may be shown on the display unit 70 during performance of the slots routine 230 shown schematically in FIG. 4. Referring to FIG. 10, the display 450 may include video images 452 of a plurality of slot machine reels, each of the reels having a plurality of reel symbols 454 associated therewith. Although the display 450 shows five reel images 452, each of which may have three reel symbols 454 that are visible at a time, other reel configurations could be utilized.

To allow the player to control the play of the slots game, a plurality of player-selectable buttons may be displayed. The buttons may include a “Cash Out” button 456, a “See Pays” button 458, a plurality of payline-selection buttons 460 each of which allows the player to select a different number of paylines prior to “spinning” the reels, a plurality of bet-selection buttons 462 each of which allows a player to specify a wager amount for each payline selected, a “Spin” button 464, and a “Max Bet” button 466 to allow a player to make the maximum wager allowable.

FIG. 12 is a flowchart of the slots routine 230 shown schematically in FIG. 10. Referring to FIG. 12, at block 470, the routine may determine whether the player has requested payout information, such as by activating the “See Pays” button 458, in which case at block 472 the routine may cause one or more pay tables to be displayed on the display unit 70. At block 474, the routine may determine whether the player has pressed one of the payline-selection buttons 460, in which case at block 476 data corresponding to the number of paylines selected by the player may be stored in the memory of the controller 100 as operational event data. At block 478, the routine may determine whether the player has pressed one of the bet-selection buttons 462, in which case at block 480 data corresponding to the amount bet per payline may be stored in the memory of the controller 100 as operational event data. At block 482, the routine may determine whether the player has pressed the “Max Bet” button 466, in which case at block 484 bet data (which may include both payline data and bet-per-payline data) corresponding to the maximum allowable bet may be stored in the memory of the controller 100 as operational event data.

If the “Spin” button 464 has been activated by the player as determined at block 486, at block 488 the routine may cause the slot machine reel images 452 to begin “spinning” so as to simulate the appearance of a plurality of spinning mechanical slot machine reels. At block 490, the routine may determine the positions at which the slot machine reel images will stop, or the particular symbol images 454 that will be displayed when the reel images 452 stop spinning. At block 492, the routine may stop the reel images 452 from spinning by displaying stationary reel images 452 and images of three symbols 454 for each stopped reel image 452. The virtual reels may be stopped from left to right, from the perspective of the player, or in any other manner or sequence.

The routine may provide for the possibility of a bonus game or round if certain conditions are met, such as the display in the stopped reel images 452 of a particular symbol 454. If there is such a bonus condition as determined at block 494, the routine may proceed to block 496 where a bonus round may be played. The bonus round may be a different game than slots, and many other types of bonus games could be provided. If the player wins the bonus round, or receives additional credits or points in the bonus round, a bonus value may be determined at block 498. A payout value corresponding to outcome of the slots game and/or the bonus round may be determined at block 500 and stored in the memory of the controller 100 as operational event data. At block 502, the player's cumulative value or number of credits may be updated by subtracting the bet made by the player and adding, if the slot game and/or bonus round was a winner, the payout value determined at block 500 which may be stored in the memory of the controller 100 as operational event data.

Although the above routine has been described as a virtual slot machine routine in which slot machine reels are represented as images on the display unit 70, actual slot machine reels that are capable of being spun may be utilized instead, in which case the display unit 70 could be provided in the form of a plurality of mechanical reels that are rotatable, each of the reels having a plurality of reel images disposed thereon.

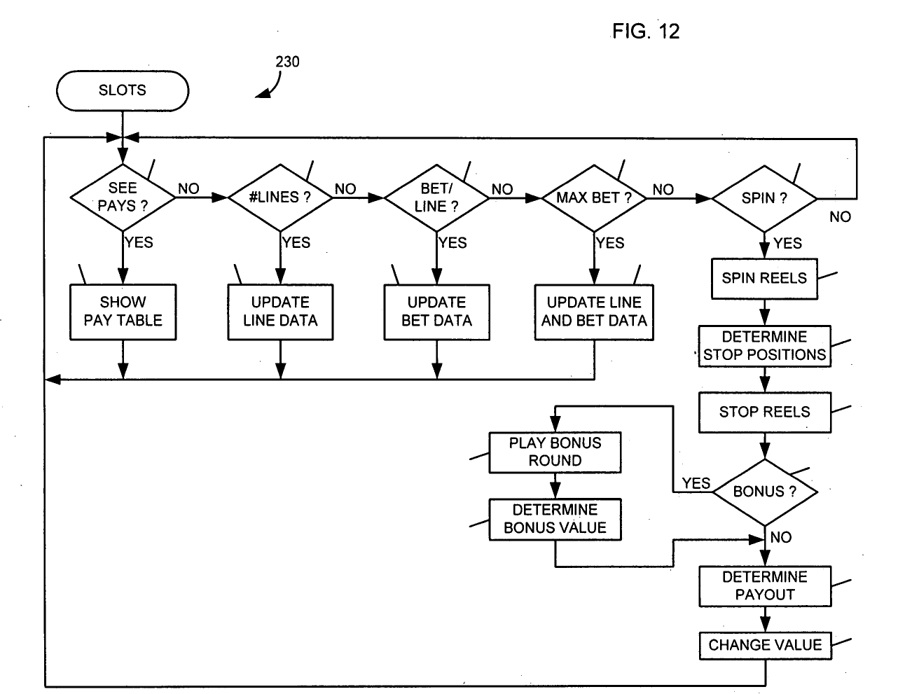

### Video Keno

Where the gaming unit 20 is designed to facilitate play of a video keno game, the display unit 70 may comprise a video display unit. FIG. 11 is an exemplary display 520 that may be shown on the display unit 70 during performance of the video keno routine 240 shown schematically in FIG. 4. Referring to FIG. 11, the display 520 may include a video image 522 of a plurality of numbers that were selected by the player prior to the start of a keno game and a video image 524 of a plurality of numbers randomly selected during the keno game. The randomly selected numbers may be displayed in a grid pattern.

To allow the player to control the play of the keno game, a plurality of player-selectable buttons may be displayed. The buttons may include a “Cash Out” button 526, a “See Pays” button 528, a “Bet One Credit” button 530, a “Bet Max Credits” button 532, a “Select Ticket” button 534, a “Select Number” button 536, and a “Play” button 538. The display 520 may also include an area 540 in which the number of remaining credits or value is displayed. If the display unit 70 is provided with a touch-sensitive screen, the buttons may form part of the video display 520. Alternatively, one or more of those buttons maybe provided as part of a control panel that is provided separately from the display unit 70.

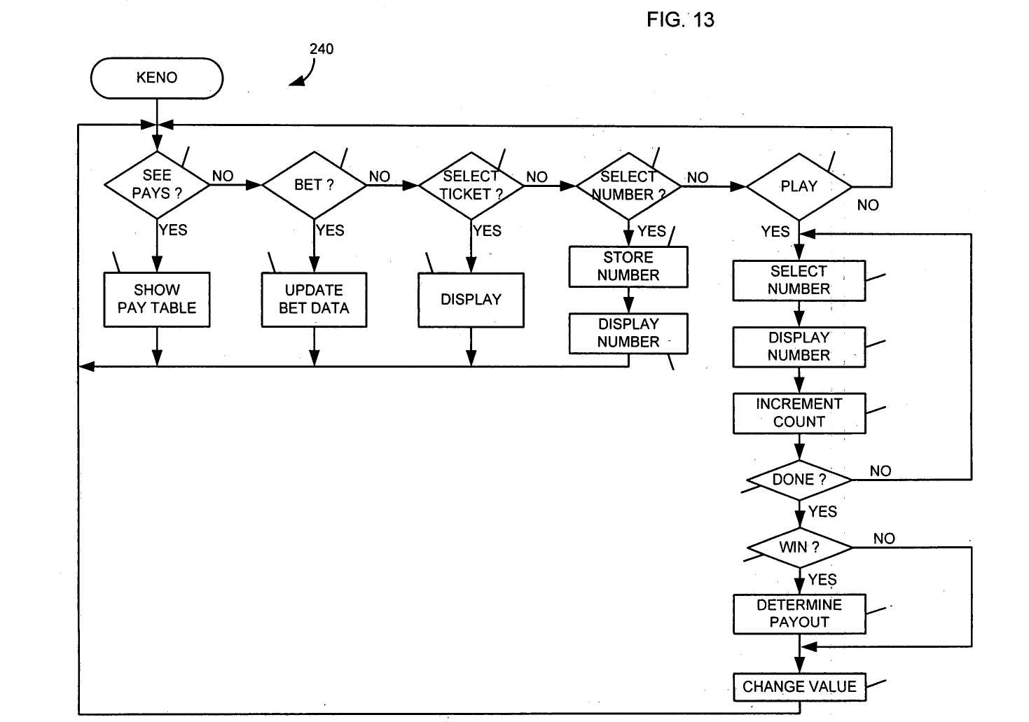

FIG. 13 is a flowchart of the video keno routine 240 shown schematically in FIG. 4. The keno routine 240 may be utilized in connection with a single gaming unit 20 where a single player is playing a keno game, or the keno routine 240 may be utilized in connection with multiple gaming units 20 where multiple players are playing a single keno game. In the latter case, one or more of the acts described below may be performed either by the controller 100 in each gaming unit or by one of the network computer 22, 32 to which multiple gaming units 20 are operatively connected.

Referring to FIG. 13, at block 550, the routine may determine whether the player has requested payout information, such as by activating the “See Pays” button 528, in which case at block 552 the routine may cause one or more pay tables to be displayed on the display unit 70. At block 554, the routine may determine whether the player has made a bet, such as by having pressed the “Bet One Credit” button 530 or the “Bet Max Credits” button 532, in which case at block 556 bet data corresponding to the bet made by the player may be stored in the memory of the controller 100 as operational event data. After the player has made a wager, at block 558 the player may select a keno ticket, and at block 560 the ticket may be displayed on the display 520. At block 562, the player may select one or more game numbers, which may be within a range set by the casino. After being selected, the player's game numbers may be stored in the memory of the controller 100 as operational event data at block 564 and may be included in the image 522 on the display 520 at block 566. After a certain amount of time, the keno game may be closed to additional players (where a number of players are playing a single keno game using multiple gambling units 20).

If play of the keno game is to begin as determined at block 568, at block 570 a game number within a range set by the casino may be randomly selected either by the controller 100 or a central computer operatively connected to the controller, such as one of the network computers 22, 32. At block 572, the randomly selected game number may be displayed on the display unit 70 and the display units 70 of other gaming units 20 (if any) which are involved in the same keno game. At block 574, the controller 100 (or the central computer noted above) may increment a count which keeps track of how many game numbers have been selected at block 570.

At block 576, the controller 100 (or one of the network computers 22, 32) may determine whether a maximum number of game numbers within the range have been randomly selected. If not, another game number may be randomly selected at block 570. If the maximum number of game numbers has been selected, at block 578 the controller 100 (or a central computer) may determine whether there are a sufficient number of matches between the game numbers selected by the player and the game numbers selected at block 570 to cause the player to win. The number of matches may depend on how many numbers the player selected and the particular keno rules being used.

If there are a sufficient number of matches, a payout may be determined at block 580 to compensate the player for winning the game. The payout may depend on the number of matches between the game numbers selected by the player and the game numbers randomly selected at block 570. At block 582, the player's cumulative value or number of credits may be updated by subtracting the bet made by the player and adding, if the keno game was won, the payout value determined at block 580. This information may be stored in the memory of the controller 100 as operational event data. The cumulative value or number of credits may also be displayed in the display area 540 (FIG. 11).

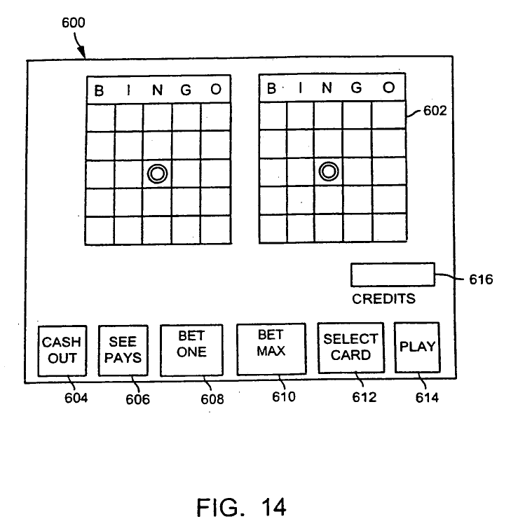

### Video Bingo

Where the gaming unit 20 is designed to facilitate play of a video bingo game, the display unit 70 may comprise a video display unit. FIG. 14 is an exemplary display 600 that may be shown on the display unit 70 during performance of the video bingo routine 250 shown schematically in FIG. 4. Referring to FIG. 14, the display 600 may include one or more video images 602 of a bingo card and images of the bingo numbers selected during the game. The bingo card images 602 may have a grid pattern.

To allow the player to control the play of the bingo game, a plurality of player-selectable buttons may be displayed. The buttons may include a “Cash Out” button 604, a “See Pays” button 606, a “Bet One Credit” button 608, a “Bet Max Credits” button 610, a “Select Card” button 612, and a “Play” button 614. The display 600 may also include an area 616 in which the number of remaining credits or value is displayed. If the display unit 70 is provided with a touch-sensitive screen, the buttons may form part of the video display 600. Alternatively, one or more of those buttons may be provided as part of a control panel that is provided separately from the display unit 70.

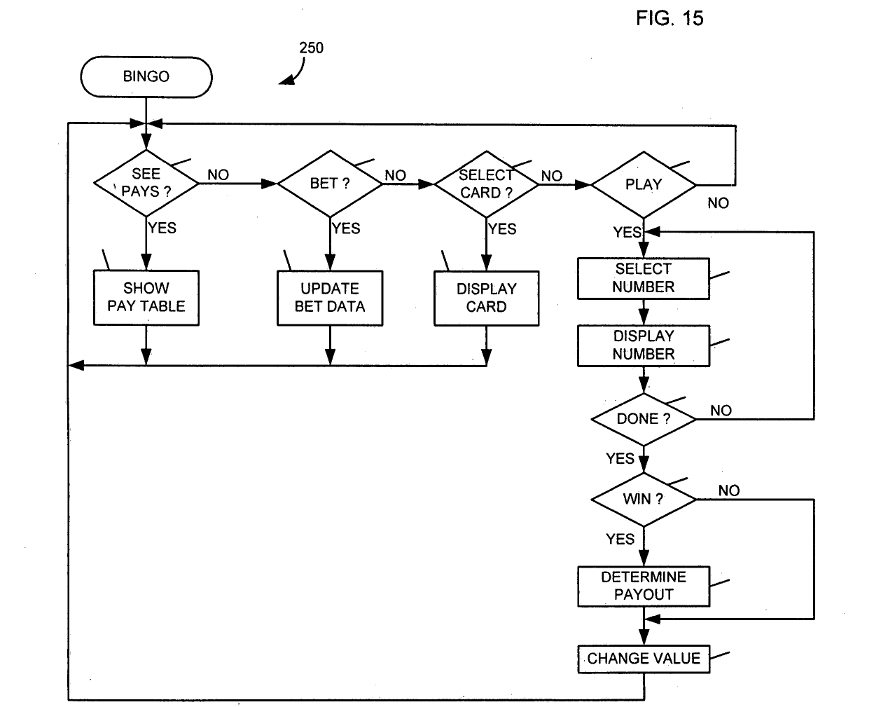

FIG. 15 is a flowchart of the video bingo routine 250 shown schematically in FIG. 4. The bingo routine 250 may be utilized in connection with a single gaming unit 20 where a single player is playing a bingo game, or the bingo routine 250 may be utilized in connection with multiple gaming units 20 where multiple players are playing a single bingo game. In the latter case, one or more of the acts described below may be performed either by the controller 100 in each gaming unit 20 or by one of the network computers 22, 32 to which multiple gaming units 20 are operatively connected.

Referring to FIG. 15, at block 620, the routine may determine whether the player has requested payout information, such as by activating the “See Pays” button 606, in which case at block 622 the routine may cause one or more pay tables to be displayed on the display unit 70. At block 624, the routine may determine whether the player has made a bet, such as by having pressed the “Bet One Credit” button 608 or the “Bet Max Credits” button: 610, in which case at block 626 bet data corresponding to the bet made by the player may be stored in the memory of the controller 100 as operational event data.

After the player has made a wager, at block 628 the player may select a bingo card, which may be generated randomly. The player may select more than one bingo card, and there may be a maximum number of bingo cards that a player may select. After play is to commence as determined at block 632, at block 634 a bingo number may be randomly generated by the controller 100 or a central computer such as one of the network computers 22, 32. At block 636, the bingo number may be displayed on the display unit 70 and the display units 70 of any other gaming units 20 involved in the bingo game.

At block 638, the controller 100 (or a central computer) may determine whether any player has won the bingo game. If no player has won, another bingo number may be randomly selected at block 634. If any player has bingo as determined at block 638, the routine may determine at block 640 whether the player playing that gaming unit 20 was the winner. If so, at block 642 a payout for the player may be determined and the determination and payout information may be stored in the memory of the controller 100 as operational event data. The payout may depend on the number of random numbers that were drawn before there was a winner, the total number of winners (if there was more than one player), and the amount of money that was wagered on the game. At block 644, the player's cumulative value or number of credits may be updated by subtracting the bet made by the player and adding, if the bingo game was won, the payout value determined at block 642. The cumulative value or number of credits may also be displayed in the display area 616 (FIG. 14) and stored in the memory of the controller 100 as operational event data.

### Operational Event Recording

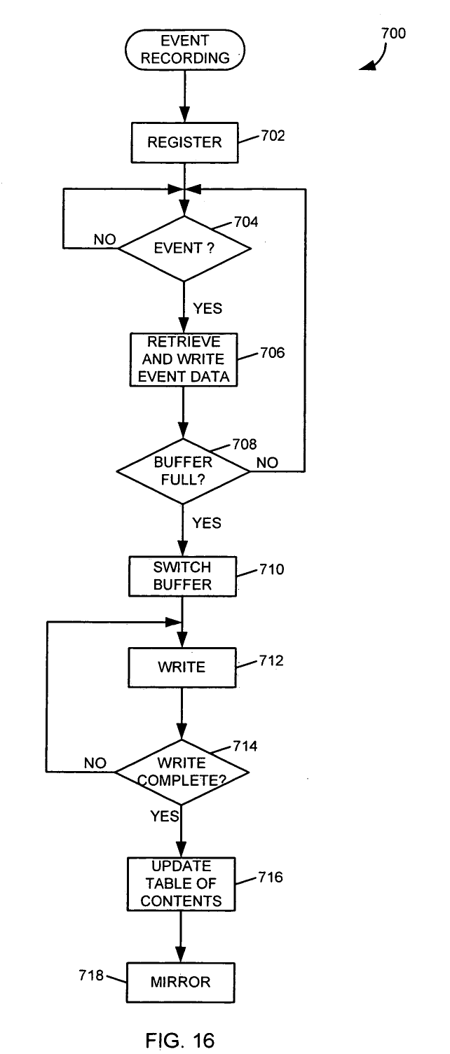

FIG. 16 is a flowchart of an operational event recording routine 700 that may be stored in the memory of the operational event controller 120. Although the following description of the routine 700 refers to recording operational events of a single gaming unit 20, the routine 700 may be used to record operational event among multiple gaming units on the network, which may depend on where the operational event controller 120 is located and the configuration of the network.

Referring to FIG. 16, the operational event recording routine 700 may begin operation at block 702 during which the operational event controller 120 may register with the gaming unit controller 100. The registration may be used to inform the gaming unit controller 100 that the operational event recorder 114 is available to be notified of all operational events that occur with the gaming unit 20. The routine 700 may then enter into a wait state to wait for an operational event to occur.

The operational event controller 120 may periodically check with the gaming unit controller 100 at block 704 to determine if an operational event has occurred. If not, the routine 700 may remain in the wait state and periodically communicate with the gaming unit controller 100 to determine if an event has occurred. Whenever the gaming unit controller 100 has determined an event has occurred, such as determining a player bet, updating bet data, determining a win, determining a payout, etc. in the above game routines 210, 220, 230, 240, 250, the controller 100 may temporarily store this operational event data in the memory of the controller 100. When the operational event controller 120 requests operational event data from the gaming unit controller 100, the controller 100 may transfer the operational event data from the memory to the operational event recorder 114. Alternatively, the operational event controller 120 may be notified by the gaming unit controller 100 whenever an operational event occurs and the operational event recorder 114 may retrieve the associated information (e.g., bet amount, time and date of the bet, payout amount, time and date of the payout amount, player identification, etc.). The operational event controller 120 may also continually poll the controller 100 for operational event data.

If an operational event has occurred as determined at block 704, at block 706 the operational event controller 120 may retrieve the operational event data relating to the operational event from the gaming unit controller 100, which may be stored in the memory of the controller 100. Upon retrieving the operational event data at block 706, the operational event controller 120 may write the operational event data to one of the memory buffers 134, 136 to store the operational event data. If the operational event recorder 114 stores operational event data for multiple gaming units 20, the operational event data may be associated with a gaming unit identification to facilitate retrieval.

Generally, the operational event controller 120 may use only one memory buffer at a time, or may include only a single memory buffer exclusively. For example, one buffer may be active and able to store data at a time, whereas the other buffer may be passive and not used to store data while the other buffer is in use. At block 706 the operational event data may thereby only be written to the active buffer.

At block 708, the routine 700 may determine whether the active memory buffer currently used for storage is full. If not, the operational event controller 120 may return to a wait state for the next operational event. If the active memory buffer is full, the operational event controller 100 may switch to the remaining memory buffer to temporarily store additional operational event data at block 710. That is, the full active memory buffer may become a passive memory buffer, whereas the previously passive memory buffer may be made the active memory buffer. As above, only the active memory buffer may receive and store operational event data.

While the remaining memory buffer is activated, the routine 700 may cause the contents of the full, now passive, memory buffer to be written to the data storage device 138 at block 712. In other words, the contents of the passive memory buffer may be flushed to the data storage device 138 while the active memory buffer continues to receive and temporarily store operational event data. By waiting until the memory buffer is full, the operational event recorder 120 may prevent continuous and excessive write operations to preserve the reliability of the data storage device 138.

The operational event data may be stored on the data storage device 138 according to the type of operational event data. For example, the data storage device 138 may be partitioned to write accounting data to a first portion, player tracking data to a second portion, cashless data to a third portion, etc. If the operational event data relates to multiple gaming units 20, the data storage device 138 may be partitioned to store operational event data according to gaming unit 20 by reading the gaming unit 20 identification in the operational event data and storing the data accordingly. Any other desirable partitioning may be used. In addition to partitioning, the operation event information may be stored chronologically according to the date and time of the event, which may be recorded as part of the operational event data for each event. During the write operation at block 712 and before the operational event data is written to the data storage device 138, the operational event data may be encrypted or encoded with digital watermarks to prevent unauthorized access, though the encryption and encoding is optional and may be performed at any point prior to the data being written to the data storage device 138.

The routine 700 may determine whether all the data from the memory buffer has been written to the data storage device at block 714. If incomplete, the write operation may continue at block 712. At block 716, the routine 700 may update a table of contents stored on the data storage device 138 to reflect the new operational event data that has been written to the data storage device 138. The table of contents may comprise any desired arrangement, including a listing of operational event data by type, date, time, applicable gaming unit, etc.

Although unalterable and read-only once written to the data storage device 138, the operational event data may be copied and searched. For example, at block 718 the operational event data may undergo a mirror operation. The operational event data stored at the operational event recorder 114 may be copied to another operational event recorder 114, which may reside on the same gaming unit 20, in another gaming unit 20, the network computer 22, etc. Likewise, the operational event data stored at the other operational event recorder 114 may be copied to the first operational event recorder 114. Each operational event recorder 114 may thereby store a mirrored copy of the operational event data on every other operational event recorder 114. This procedure may be performed periodically such as once an hour, once a day, etc., continuously or following every write operation to the data storage device. The operational event recorders 114 may be stored in geographically separate locations. Should one of the operational event recorders 114 fail and the operational event data stored thereon is lost, the remaining operational event recorder 114 may provide a copy of the data stored on the failed operational event recorder 114. The contemporaneousness of the copy may depend on the frequency of the mirror operation.

The server computers 46A-46E may search for and retrieve information as needed from the operational event recorder 114. For example, the accounting server 46A may query the operational event recorder 114 for all accounting data for a particular gaming unit 20, a group of gaming units 20 or all gaming units 20. Because the operational event data on the data storage device 138 is unalterable, the server computers 46A-46E may query the operational event recorder 114 for operational event data on a particular date and time or operational event data spanning a period of time. Unless the data storage device 138 has been removed (e.g., filled to capacity), the operational event data stored thereon may span the operational life of a gaming unit 20. Data storage devices 138 that have been removed may be cataloged and stored for future data mining and auditing.

1. A gaming system comprising:
a server computer;
a network computer operatively coupled to said server computer, said network computer comprising a single-write data storage device and an operational event controller operatively coupled to said single-write data storage device, said operational event controller comprising a processor and a memory operatively coupled to said processor,
said operational event controller being programmed to retrieve operational event data,
said operational event controller being programmed to permanently store said operational event data on said data storage device, and
said operational event controller being programmed to communicate said operational event data to said server computer upon a request from said server computer for said operational event data, a plurality of gaming apparatuses operatively coupled to said network computer, each gaming apparatus comprising:
a display unit,
a ticket printer capable of generating ticket vouchers,
a value input device, and
a controller operatively coupled to said display unit, said ticket printer and said value input device, said controller comprising a processor and a memory operatively coupled to said processor,
said controller being programmed to cause said display unit to generate a game display relating to a game,
said controller being programmed to determine a value payout associated with an outcome of said game,
said controller being programmed to communicate said operational event data to said operational event controller, said operational event data comprising one or more of the following data types: accounting data, cashless data, security data, player tracking data and maintenance data, and
said controller being programmed to cause said ticket printer to issue a ticket voucher comprising at least a portion of said operational event data.

2. A gaming system as defined in claim 1 further comprising a plurality of server computers, wherein said operational event controller is programmed to communicate said operational event data to a particular server computer based on said data type.

3. A gaming system as defined in claim 1, further comprising a plurality of said network computers operatively coupled to said server computer and each disposed in a different geographic location, wherein:
said operational event controller is programmed to communicate said operational event data to an operational event controller of at least one of said plurality of network computers, and said operational event controller is programmed receive operational event data from an operational event controller of at least one of said plurality of network computers.

4. A gaming system as defined in claim 1, wherein said gaming system comprises a government-sponsored gaming system.

5. A gaming system as defined in claim 1, wherein said gaming system comprises a casino gaming system.

6. A gaming apparatus comprising:
a display unit;
a value input device;
a single-write data storage device;
a controller operatively coupled to said display unit, said value input device and said data storage device, said controller comprising a processor and a memory operatively coupled to said processor,
said controller being programmed to cause said display unit to generate a game display relating to one of the following games: poker, blackjack, slots, keno or bingo,
said controller being programmed to communicate data representing operational events on said gaming apparatus to said single-write data storage device,
said controller being programmed to determine a value payout associated with an outcome of said game,
said controller being programmed to issue a ticket voucher comprising at least a portion of said operational event data and said value payout.

7. A gaming apparatus as defined in claim 6, wherein said display unit comprises a video display unit that is capable of generating video images.

8. A gaming apparatus as defined in claim 7,
wherein said controller is programmed to cause a video image comprising an image of at least five playing cards to be displayed if said game comprises video poker,
wherein said controller is programmed to cause a video image comprising an image of a plurality of simulated slot machine reels to be displayed if said game comprises video slots,
wherein said controller is programmed to cause a video image comprising an image of a plurality of playing cards to be displayed if said game comprises video blackjack,
wherein said controller is programmed to cause a video image comprising an image of a plurality of keno numbers to be displayed if said game comprises video keno,
wherein said controller is programmed to cause a video image comprising an image of a bingo grid to be displayed if said game comprises video bingo.

9. A gaming apparatus as defined in claim 6, wherein said display unit comprises at least one mechanical slot machine reel.

10. A gaming apparatus as defined in claim 6, wherein said single-write data storage device comprises a single-write solid state memory.

11. A gaming apparatus as defined in claim 6, wherein said single-write data storage device comprises a single-write optical disk and an optical disk drive.

12. A gaming apparatus as defined in claim 6, wherein said single-write data storage device comprises a single-write magnetic disk and a magnetic disk drive.

13. A gaming apparatus as defined in claim 6, wherein said controller is programmed to encrypt said operational event data.

14. A gaming apparatus as defined in claim 6, wherein said controller is programmed to insert one or more digital watermarks in said operational event data.

15. A gaming apparatus as defined in claim 6, wherein said operational event data comprises one or more of the following data types: accounting data, cashless data, security data, player tracking data and maintenance data.

16. A gaming apparatus as defined in claim 6, wherein
said controller is programmed to issue a ticket voucher comprising one or more of the following information types: a number of games played by a player on said gaming apparatus, an amount won by the player on said gaming apparatus, an amount lost by said player on said gaming apparatus, an amount wagered by said player on said gaming apparatus, a number of coins inputted by said player to said gaming apparatus, a number of bills inputted by said player to said gaming apparatus, an identification of said gaming apparatus, an identification of a casino where said gaming apparatus is disposed, a time and a date,
wherein said controller is programmed to communicate said information types of said ticket voucher as operational event data to said single-write data storage device.

17. A gaming apparatus as defined in claim 6, wherein said game comprises a government-sponsored lottery game.

18. A gaming apparatus as defined in claim 6, wherein said game comprises a casino game.

19. A gaming apparatus as defined in claim 6, wherein said gaming apparatus is disposed in a casino.

20. A gaming apparatus as defined in claim 6 further comprising a housing, wherein said value input device, said data storage device and said controller are located within said housing.

21. A gaming apparatus as defined in claim 6 further comprising:
a memory buffer; and
an operational event controller operatively coupled to said data storage device, said controller and said memory buffer, said operational event controller comprising a processor and a memory operatively coupled to said processor,
said operational event controller being programmed to retrieve said operational event data from said controller;
said operational event controller being programmed to communicate said operational event data to said memory buffer,
said operational event controller being programmed to periodically transfer said operational event data from said memory buffer to said single-write data storage device,
wherein said controller is programmed to communicate said operational event data to said operational event controller.

22. A gaming apparatus as defined in claim 21, wherein said memory buffer comprises non-volatile memory.

23. A gaming system comprising a plurality of gaming apparatuses as defined in claim 6, said gaming apparatuses being interconnected to form a network of gaming apparatuses.

24. A gaming system as defined in claim 23, wherein said controller is programmed to retrieve operational event data from each of said gaming apparatuses and communicate said received operational event data to said data storage device.

25. A gaming system as defined in claim 23, wherein each controller is programmed to communicate said operational event data to a data storage device of at least one of said plurality of gaming apparatuses.

26. A gaming system as defined in claim 23 further comprising a network computer operatively coupled to each of said gaming apparatuses, said network computer comprising said data storage device, an operational event controller operatively coupled to said data storage device, said operational event controller comprising a processor and a memory operatively coupled to said processor,
said operational event controller being programmed to retrieve said operational event data from a controller of each of said gaming apparatuses, and
said operational event controller being programmed to communicate said operational event data to said single-write data storage device.

27. A gaming system as defined in claim 23 further comprising a plurality of server computers operatively coupled to said plurality of gaming apparatuses, wherein:
said controller is programmed to communicate said operational event data to said data storage device, said operational event data comprising one or more of the following data types: accounting data, cashless data, security data, player tracking data and maintenance data,
said controller is programmed to communicate said operational event data to a particular server computer based on said data type.

28. A gaming system as defined in claim 23, wherein said gaming apparatuses are interconnected via the Internet.

29. A gaming apparatus comprising:
a display unit;
a value input device;
a single-write data storage device;
a controller operatively coupled to said display unit, said value input device and said data storage device, said controller comprising a processor and a memory operatively coupled to said processor,
said controller being programmed to receive data representing a payline selection made by a player,
said controller being programmed to cause a game display to be generated by said display unit, said game display comprising images of a plurality of slot machine symbols each of which is associated with a respective slot machine reel of a slots game,
said controller being programmed to communicate data representing operational events on said gaming apparatus to said single-write data storage device,
said controller being programmed to determine a value payout associated with an outcome of said slots game, said controller being programmed to determine said outcome of said slots game based on a configuration of said slot machine symbols,
said controller being programmed to issue a ticket voucher comprising at least a portion of said operational event data and said value payout.

30. A gaming apparatus as defined in claim 29, wherein said display unit comprises a video display unit that is capable of generating video images.

31. A gaming apparatus as defined in claim 30, wherein said controller is programmed to cause a video image comprising an image of a plurality of simulated slot machine reels to be displayed on said display unit.

32. A gaming apparatus as defined in claim 29, wherein said display unit comprises at least one mechanical slot machine reel.

33. A gaming apparatus as defined in claim 29, wherein said controller is programmed to receive payline data representing a number of paylines selected by the player.

34. A gaming apparatus as defined in claim 29, wherein said single-write data storage device comprises a single-write solid state memory.

35. A gaming apparatus as defined in claim 29, wherein said single-write data storage device comprises a single-write optical disk and an optical disk drive.

36. A gaming apparatus as defined in claim 29, wherein said single-write data storage device comprises a single-write magnetic disk and a magnetic disk drive.

37. A gaming apparatus as defined in claim 29, wherein said controller is programmed to encrypt said operational event data.

38. A gaming apparatus as defined in claim 29, wherein said controller is programmed to insert one or more digital watermarks in said operational event data.

39. A gaming apparatus as defined in claim 29, wherein said operational event data comprises one or more of the following data types: accounting data, cashless data, security data, player tracking data and maintenance data.

40. A gaming apparatus as defined in claim 29, wherein:
said controller is programmed to issue a ticket voucher comprising one or more of the following information types: a number of games played by a player on said gaming apparatus, an amount won by the player on said gaming apparatus, an amount lost by said player on said gaming apparatus, an amount wagered by said player on said gaming apparatus, a number of coins inputted by said player to said gaming apparatus, a number of bills inputted by said player to said gaming apparatus, an identification of said gaming apparatus, an identification of a casino where said gaming apparatus is disposed, a time, a date and a player identification,
wherein said controller is programmed to communicate said information types of said ticket voucher as operational event data to said single-write data storage device.

41. A gaming apparatus as defined in claim 29 further comprising:
a memory buffer; and
an operational event controller operatively coupled to said data storage device, said controller and said memory buffer, said operational event controller comprising a processor and a memory operatively coupled to said processor,
said operational event controller being programmed to retrieve said operational event data from said controller;
said operational event controller being programmed to communicate said operational event data to said memory buffer,
said operational event controller being programmed to periodically transfer said operational event data from said memory buffer to said single-write data storage device,
wherein said controller is programmed to communicate said operational event data to said operational event controller.

42. A gaming system comprising a plurality of gaming apparatuses as defined in claim 29, said gaming apparatuses being interconnected to form a network of gaming apparatuses.

43. A gaming system as defined in claim 42, wherein said controller is programmed to retrieve operational event data from each of said gaming apparatuses and communicate said received operational event data to said data storage device.

44. A gaming system as defined in claim 42, wherein each controller is programmed to communicate said operational event data to a single-write data storage device of at least one of said plurality of gaming apparatuses.

45. A gaming system as defined in claim 42 further comprising a network computer operatively coupled to each of said gaming apparatuses, said network computer comprising said data storage device, an operational event controller operatively coupled to said data storage device, said operational event controller comprising a processor and a memory operatively coupled to said processor,
said operational event controller being programmed to retrieve said operational event data from a controller of each of said gaming apparatuses, and
said operational event controller being programmed to communicate said operational event data to said single-write data storage device.

46. A gaming system as defined in claim 42 further comprising a plurality of server computers operatively coupled to said plurality of gaming apparatuses, wherein:
said controller is programmed to communicate said operational event data to said data storage device, said operational event data comprising one or more of the following data types: accounting data, cashless data, security data, player tracking data and maintenance data,
said controller is programmed to communicate said operational event data to a particular server computer based on said data type.

47. A memory having a computer program stored therein, said computer program being capable of being used in connection with a gaming apparatus, said memory comprising:
a memory portion physically configured in accordance with computer program instructions that would cause the gaming apparatus to cause a game display representing one of the following games to be generated: poker, blackjack, slots, keno or bingo,
a memory portion physically configured in accordance with computer program instructions that would cause the gaming apparatus to communicate data representing operational events on said gaming apparatus to a single-write data storage device, said operational event data comprising one or more of the following data types: accounting data, cashless data, security data, player tracking data and maintenance data,
a memory portion physically configured in accordance with computer program instructions that would cause the gaming apparatus to determine a value payout associated with an outcome of said one game, and
a memory portion physically configured in accordance with computer program instructions that would cause the gaming apparatus to issue a ticket voucher comprising at least a portion of said operational event data and said value payout.
